(19) United States
(12) Patent Application Publication
(10) Pub. No.: US 2015/0378836 A1
(43) Pub. Date: Dec. 31, 2015

(54) Data Backup Recovery

(71) Applicant: INTERNATIONAL BUSINESS MACHINES CORPORATION, Armonk, NY (US)

(72) Inventors: Christopher B. Beeken, Eastleigh (GB); Carlos F. Fuente, Hampshire (GB)

(21) Appl. No.: 14/760,056

(22) PCT Filed: Dec. 19, 2013
(86) PCT No.: PCT/IB2013/061134

§ 371 Date: Jul. 9, 2015

(30) Foreign Application Priority Data
Jan. 17, 2013 (GB) 1300860.2

(51) Int. Cl. G06F 11/14; G06F 17/30

(52) U.S. Cl. CPC G06F 11/1453; G06F 17/30575; G06F 17/30371; G06F 2201/84

(57) ABSTRACT

A mechanism is provided for recovering a data backup comprising a data image and a point-in-time copy of the data image. A virtual data image storage device is provide for storing a copy of the data image, and a virtual snapshot storage device is provided for storing data of the point-in-time copy. The data image is copied to the virtual data image storage device, and data from the point-in-time copy of the data image is copied to the virtual snapshot storage device responsive to the data not existing in the virtual data image storage device.

### BACKGROUND

This invention relates to the field of recovery of data in computer systems and more particularly to recovering data backups.

Users of computer systems have a need to create periodic backups of their production data while minimizing the storage used, the impact on the production I/O and the time that the backups are dependent on the production data.

Using a space-efficient FlashCopy® (FlashCopy is a Registered Trademark of IBM Corporation in the United States, other countries, or both) helps the user minimize the storage used for backups and that using a FlashCopy solution implemented using a cascade algorithm will minimize the impact of the backups on the production I/O. At the highest level, FlashCopy is a function where a second image of ‘sonic data’ is made available. This function is sometimes known in other system contexts as Point-In-Time copy, a T0-copy, or a Snapshot. The second image's contents are initially identical to that of the first. The second image is made available ‘instantly’. In practical terms this means that the second image is made available in much less time than would be required to create a true, separate, physical copy, and that this means that it can be established without unacceptable disruption to a using application's operation.

Once established, the second copy can be used for a number of purposes including performing backups, system trials, and data mining. The first copy continues to be used for its original purpose by the original using application. Contrast this with backup without FlashCopy, where the application must be shut down, and the backup taken, before the application can be restarted again. It is becoming increasingly difficult to find time windows where an application is sufficiently idle to be shut down. The cost of taking a backup is increasing. There is thus significant and increasing business value in the ability of FlashCopy to allow backups to be taken without stopping the business.

FlashCopy implementations achieve the illusion of the existence of a second image by redirecting read I/O addressed to the second image (henceforth Target or Snapshot) to the original image (henceforth Source or Data Image), unless that region (also known as a “grain”) has been subject to a write. Where a region has been the subject of a write (to either Data Image or Snapshot), then to maintain the illusion that both Data Image and Snapshot own their own copy of the data, a process is invoked which suspends the operation of the write command, and without it having taken effect, issues a read of the affected region from the Data Image, applies the read data to the Snapshot with a write, then (and only if all steps were successful) releases the suspended write. Subsequent writes to the same region do not need to be suspended since the Snapshot will already have its own copy of the data. This copy-on-write technique is used in many environments.

Some storage controllers allow a user to configure more than one target for a given source, also known as multiple target FlashCopy. This has a number of applications. For instance, different experiments could be run against each of the targets. Or the targets might be taken at different times (e.g. different days in the week), and allow historical access to the disk, perhaps for the purpose of recovering from some data corruption, such as might be caused by a virus. One form of multiple-target FlashCopy is cascaded FlashCopy.

When recovering from a disaster, which has caused a catastrophic loss of stored date for example, backups of the data may be used to recover the lost data. Recovery of such backed-up data typically comprises copying the backed-up to a computer system that requires the data. Minimizing the storage capacity used to recover the backup data is a requirement for most users.

### SUMMARY

There proposed a concept for recovering a backup of a data image and a point-in-time copy of the data image whilst reducing the size of the recovered point-in-time copy. By only writing data to the recovered point-in-time copy that has not been written to the recovered data image, embodiments may reduce the amount of data written to the recovered point-in-time copy, thereby avoiding data replication and minimising the required data storage space for the recovered data.

Embodiments may be used in conjunction with a backup created using a FlashCopy function, thus enabling recovery of a data image and a snapshot whilst minimising the size of the recovered snapshot.

In one illustrative embodiment, a method, in a data processing system, is provided for recovering a data backup comprising a data image and a point-in-time copy of the data image. The illustrative embodiment provides a virtual data image storage device for storing a copy of the data image. The illustrative embodiment copies the data image to the virtual data image storage device. The illustrative embodiment provides a virtual snapshot storage device for storing data of the point-in-time copy of the data image. The illustrative embodiment maps the virtual snapshot storage device to data of the virtual data image storage device. The illustrative embodiment determines whether data of the point-in-time copy of the data image exists in the virtual data image storage device. The illustrative embodiment copying data from the point-in-time copy of the data image to the virtual snapshot storage device responsive to the data not existing in the virtual data image storage device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of and combinations of, the operations outlined above with regard to the method illustrative embodiment.

These and other features and advantages of the present invention wilt be described in, or will become apparent to those of ordinary skill in the art in view of, the following detailed description of the example embodiments of the present invention.

### BRIEF DESCRIPTION OF THE DRAWINGS

Preferred embodiments of the present invention will now be described, by way of example only, with reference to the following drawings in which:

FIG. 1 depicts the storage of backup data recovered in accordance with an embodiment;

FIG. 2 depicts a modification o the embodiment of FIG. 1;

FIG. 3 is a schematic block diagram of a backup data recovery system according to an embodiment;

FIG. 4 is a flow diagram of a method according to an embodiment of the invention; and

FIG. 5 is a schematic block diagram of computer system according to an embodiment of the invention.

### DETAILED DESCRIPTION

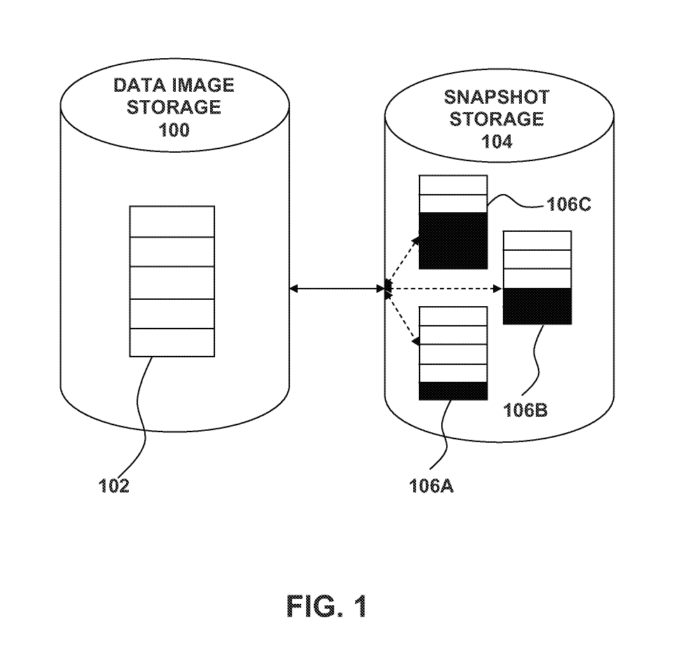

Referring to FIG. 1, there is a depicted the storage of backup data recovered in accordance with an embodiment. Here, a data image storage device 100, such as a first hard-disk drive (HDD), is adapted to store a data image 102 that has been recovered from a backup created using a FlashCopy function. The data image 102 comprises a complete copy of a Source or Data Image stored on a data backup device. Further, a snapshot storage device 104, such as a second hard-disk drive (HDD), is adapted to store a first to third snapshots 106A-106C that have been recovered from a backup created using a FlashCopy function. The first to third snapshots 106A-106C comprise data copied from first to third Targets or Snapshots (i.e. point-in-time copies) stored on the data backup device.

The data image storage device 100 and the snapshot storage device 104 could form part of a larger array of storage devices, and would typically form part of an enterprise storage solution. The storage devices could be part of a storage solution relating to a commercial website, for example.

In this embodiment, the data image 102 and the first to third snapshots 106A-106C have been recovered from the data backup device in accordance with a proposed method that reduces the amount of storage space required to store the recovered snap shots 106A-106C. In brief, data is only written to a recovered snapshot if it has not been written to the recovered data image 102, thereby avoiding data replication between the recovered data image 102 and the recovered snapshots 106A-106C.

This concept of only storing minimal data is illustrated by the black regions/blocks of the recovered snapshots 106A-106C in FIG. 1. The black regions/blocks of each of the recovered snapshots 106A-106C depict data copied from the backed-up snapshots (stored on the backup device) which is not already contained in the data image 102. Conversely, the white regions/blocks of each of the recovered snapshots 106A-106C depict un-used storage areas wherein data from the corresponding backed-up snapshots is not stored in the recovered snapshots 106A-106C but can instead be read from the data image 102. In other words, the unused areas of the recovered snapshots 106A-106C are mapped to data in the data image 102, thus removing the need to store such data in the recovered snapshots 106A-106C.

In this example, the first to third recovered snapshots 106A-106C are recovered from backed-up point-in-time copies of the data image at first to third progressive dates, respectively. In other words, the first recovered snapshot 106A corresponds to a first point-in-time copy of the data image at a first date wherein an initial amount of data in the data image 102 has been changed from its original incarnation, the second recovered snapshot 106B corresponds to a second point-in-time copy of the data image at a second (later) date wherein a further amount of data in the data image 102 has been changed from the first point-in-time copy, and the third recovered snapshot 106C corresponds to a third point-in-time copy of the data image at a third (even later) date wherein a yet further amount of data in the data image 102 has been changed from the second point-in-time copy. Less data in the third recovered snapshot 106C can therefore be mapped directly from the data image 102, since a greater amount of data in the third recovered snapshot 106C differs from the initial incarnation of the data image. This is illustrated by the greater number of black regions/blocks depicted in the third recovered snapshot 106C of FIG. 1.

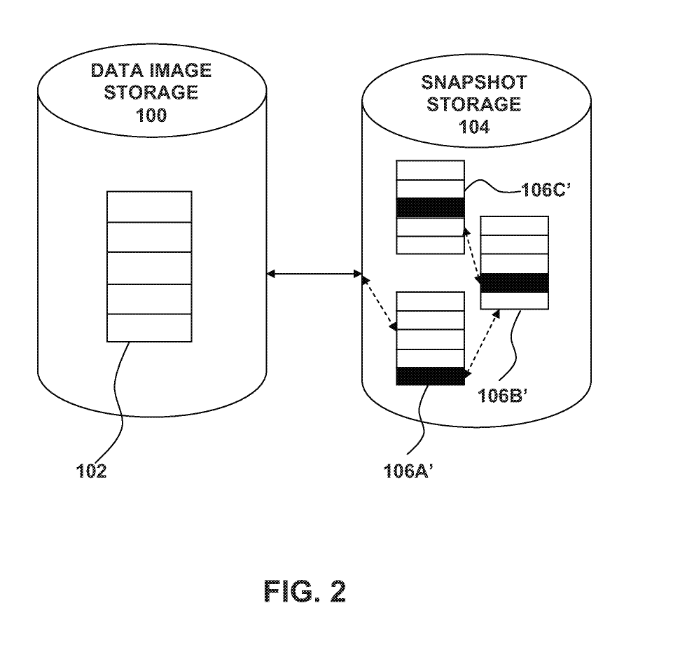

It will, however, be understood by a skilled reader, that, in another embodiment, the recovered snapshots may be cascaded so that they only contain data that differs from the snapshots and the data image earlier in the cascade. This concept of storing recovered snapshots in a cascaded fashion is depicted in FIG. 2, wherein the recovered snapshots 106A′-106C′ are mapped in a chained fashion so as to refer identical data in a former snapshot and/or the data image and thereby only store data unique to the recovered snapshot.

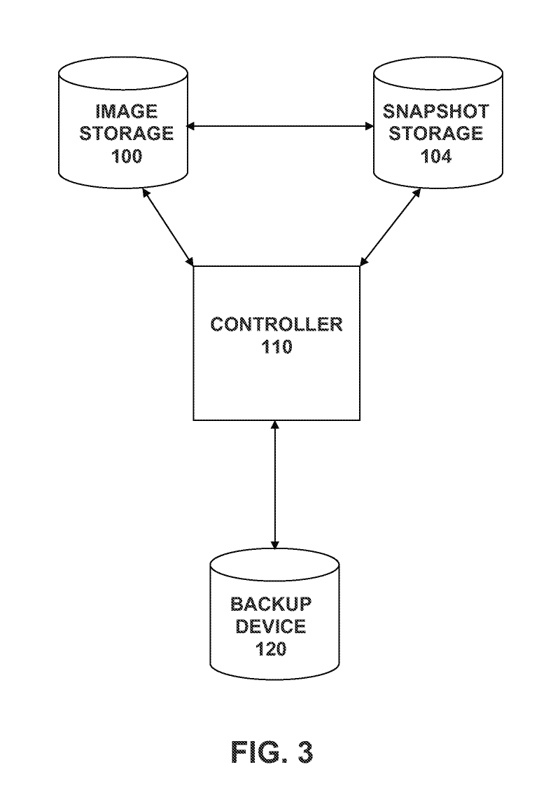

FIG. 3 shows an arrangement of apparatus (e.g. a system) for the implementation of data backup recovery according to one embodiment. Data image storage device 100 is the store of physical storage available for storing a data image (e.g. production data) from a Backup Device 120. Snapshot storage device 104 is the store of space-efficient storage available for storing snapshots (i.e. point-in-time copies) of the data image from the Backup Device 120. Controller 110 controls the creation of the storage required for the recovery of the backed-up data. Controller 110 also controls the sequence of events required to successfully execute a backup recovery policy. Backup device 120 thus stores the backed-up data (Including the backed-up data image and associated snapshots).

The controller 110 is adapted to create a virtual disk in the data image storage device 100 for storing a recovered data image, and to copy the data of a backed-up data image from the backup device 120 to the created virtual disk. Thus, in other words, the controller 110 is adapted to create a recovered version of the backed-up data image on the data image storage device 100.

The controller 110 is also adapted to create a virtual snapshot disk in the snapshot storage device 104 for each snapshot stored by the backup device 120, and to map each of the virtual snapshot disks to the data of the recovered data image (stored in the data image storage device 100). For each of the virtual snapshot disks, the controller 110 determines if data in the corresponding snapshot stored by the backup device 120 already exists in the recovered data image. If the controller 110 determines that the data already exists in the recovered data image, the controller 110 does not copy the data from the backup device 120 to the virtual snapshot disk, but instead ensures that the virtual snapshot disk is mapped to the data in the recovered data image. Conversely, if the controller 110 determines that the data does not already exist in the recovered data image, the controller 110 copies the data from the backup device 120 to the virtual snapshot disk.

The controller 110 is thus adapted to only write data from a snapshot stored by the backup device 120 to a corresponding virtual snapshot disk (stored by the snapshot storage device) if it is not already part of the data image (stored by the data image storage device 100). This concept of recovering data from a backup device 120 avoids repetition of data in the recovered data image and snapshot(s), thereby reducing the amount of storage space used by the recovered snapshot(s) in the snapshot storage device 104.

In an alternative embodiment, the controller 110 may be further adapted to generate data representing a mapping relationship between a recovered snapshot and the recovered data image for data that is not copied from the backed-up snapshot. Such mapping data may comprise a table, structured data, meta-data, or the like, and be stored by the controller 110 (in associated data storage means) or stored in either of the data image storage device 100 or the snapshot storage device 104.

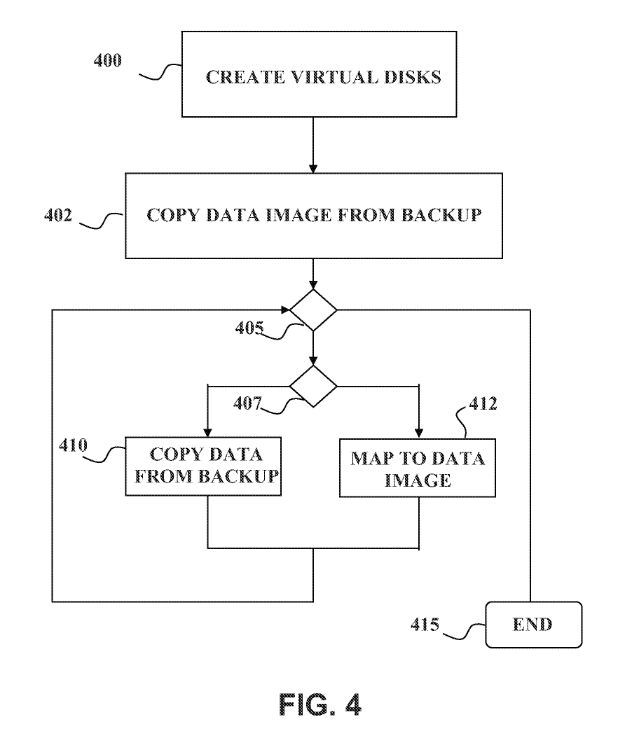

Turning now to FIG. 4, there is depicted a flow diagram of a method of recovering a data backup comprising a data image and a snapshot (i.e. point-in-time copy) of the data image to an embodiment of the invention. The method begins in step 400 in which a virtual data image disk for each of the data image and the snapshot is created in a data storage device (such as a HDD or a network-accessible data repository, for example). This step 400 of creating virtual disks comprises allocating space in the data storage device for storing data copied from the backed-up data. Thus, a virtual data image disk is created for storing data of the data image, and a virtual snapshot disk is created for storing data of the snapshot.

Next, in step 402, the entire data image is copied from the backup to the virtual data image disk. Thus, the data image of the backup is replicated in the virtual data image disk, thereby recovering the data image from the backup (to the virtual data image disk of the data storage device).

The method then proceeds to step 405, wherein it is determined there exists data the snapshot which is yet to be recovered. In other words, step 405 checks if there is further data that has not been recovered from the snapshot of the data backup. If there is data to be recovered, the method continues to step 407. However, if there is no further data to be recovered from the snapshot of the data backup (e.g. the snapshot has been fully recovered), the method proceeds to step 415 and ends.

In step 407, it determined if data of the snapshot exists in the virtual data image disk. Put another way, step 407 checks whether the data of the snapshot has already been written to the virtual data image disk. If it is determined that the data does not exist in the virtual image disk, the method proceeds to step 410 wherein the data is copied from the snapshot (of the backup) to the virtual snapshot disk before returning to method step 405. Conversely, if it is determined that the data does already exist in the virtual data image disk, the method proceeds to step 412 wherein, instead of copying the data from the snapshot, the method maps the virtual snapshot disk to that data of the virtual image disk before returning to method step 405.

The method therefore only copies data from the snapshot of the backup to the virtual snapshot disk if it has not already been copied from the backup, thereby avoiding repetition of copying and repetition of data in the data storage device. Consequently, the recovered snapshot created in the data storage device by the method shown in FIG. 4 may be understood to be a ‘thin’ or ‘incremental’ snapshot that (despite representing the entire data of a data image at a particular time) only comprises differential data (i.e. data that is different from the data of the data image). The unchanged data can thus be retrieved from the data image via an appropriate mapping from the thin/incremental snapshot.

Although the above embodiment of FIG. 4 has been described in relation to recovering data from a backup comprising a data image and a single snapshot, other embodiments may be equally applicable to backups comprising a plurality of snapshots. In such embodiments, the snapshots may be recovered so as to be independent from each other (e.g. like those depicted in FIG. 1), thus meaning the recovery method only checks the data of the recovered data image (i.e. the virtual data image disk) to see if the data already exists in the recovered data image before deciding whether or not to copy the data from the backup or not. In other embodiment, the snapshots may be recovered so as to be cascaded (e.g. like those depicted in FIG. 2), thus meaning the recovery method checks the data of the recovered data image the virtual data image disk) and earlier/former snapshots in the cascade chain to see if the data already exists in the recovered data image or recovered snapshots before deciding whether or not to copy the data from the backup or not.

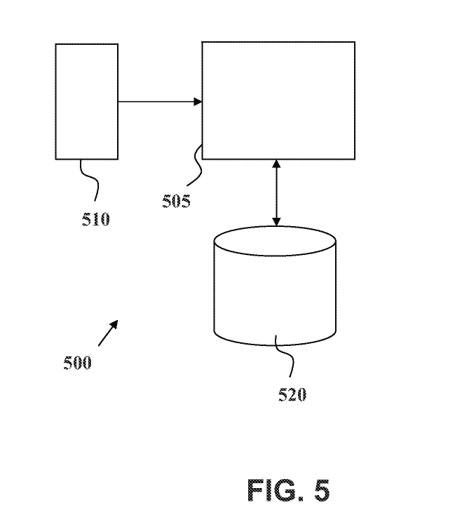

Referring now to FIG. 5, there is illustrated a schematic block diagram of a computer system 500 according to an embodiment. The computer system 500 is adapted to recover data from a backup comprising a data image and snapshot (i.e. point-in-time copy) of the data image. The system comprises a processing unit 505 having an input 510 interface, and a data storage unit 520 connected to the processing unit 505.

The input interface 510 is adapted to receive data from a backup comprising a data image and snapshot (i.e. point-in-time copy) of the data image.

The data storage unit 520 is adapted to store data recovered from the backup. In other words, the data storage unit 520 is adapted to store recovered a version of the data image and snapshot received via the input interface 510.

The processing unit 505 is adapted to execute a computer program which, when executed, causes the system to implement the steps of a method according to an embodiment, for example the steps as shown in FIG. 4.

The processing unit 505 is adapted to receive, via the input interface 510, a backup comprising a data image and snapshot (i.e. point-in-time copy) of the data image.

The processing unit 505 creates a virtual data image disk in the data storage unit 520 for storing a recovered data image, and copies the data of the data image from the backup device to the created virtual data image disk. Thus, processing unit 505 duplicates the data image of the backup in the virtual data image disk of the data storage device 520.

The processing unit 505 also creates adapted to create a virtual snapshot disk in the data storage unit 520 for the snapshot of the backup, and then maps the virtual snapshot disk to the data of the virtual data image disk.

For each piece of data snapshot disk, the processing unit 505 determines if the piece of data already exists in the virtual data image disk. If the processing unit 505 determines that the piece of data already exists in the virtual data image disk, the piece of data is not copied from the snapshot of the backup to the virtual snapshot disk, but instead processing unit 505 ensures that the virtual snapshot disk is mapped to the piece of data in the virtual data image disk. Conversely, if the processing unit 505 determines that the piece of data does not already exist in the virtual data image disk, the processing unit 505 copies the piece of data from the snapshot to the virtual snapshot disk.

The processing unit 505 thus only writes data from a snapshot to the corresponding virtual snapshot disk (stored in the data storage device) if it is not already part of the virtual data image disk.

Embodiments may thus provide an apparatus and method for recovering data backups including snapshots while reducing the size of the recovered snapshots, It will be clear to one of ordinary skill in the art that all or part of the method of one embodiment of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to one embodiment of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The present invention may further suitably be embodied as a computer program product for use with a computer system. Such an implementation may comprise a series of computer-readable instructions either fixed on a tangible medium, such as a computer readable medium, for example, e.g. a CD-ROM, DVD, USB stick, memory card, network-area storage device, internet-accessible data repository, and so on, or transmittable to a computer system, via a modem or other interface device, over either a tangible medium, including hut not limited to optical or analogue communications lines, or intangibly using wireless techniques, including but not limited to microwave, infrared or other transmission techniques. The series of computer readable instructions embodies all or part of the functionality previously described herein,

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In one alternative, one embodiment may be realized in the form of a computer implemented method of deploying a service comprising steps of deploying computer program code operable to cause the computer system to perform all the steps of the method when deployed into a computer infrastructure and executed thereon.

In a further alternative, one embodiment my be realized in the form of a data carrier having functional data thereon, the functional data comprising functional computer data structures to, when loaded into a computer system and operated upon thereby, enable the computer system to perform all the steps of the method.

The flowchart and block diagram in the above figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While one or more embodiments have been illustrated in detail, one of ordinary skill in the art will appreciate that modifications and adaptations to those embodiments may be made.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RIP, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the Hock may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Other variations to the disclosed embodiments can be understood and effected by those skilled in the art in practising the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A method, in a data processing system, for recovering a data backup comprising a data image and a point-in-time copy of the data image, the method comprising:
providing a virtual data image storage device for storing a copy of the data image;
copying the data image to the virtual data image storage device;
providing a virtual snapshot storage device for storing data of the point-in-time copy of the data image;
mapping the virtual snapshot storage device to data of the virtual data image storage device;
determining whether data of the point-in-time copy of the data image exists in the virtual data image storage device; and
copying data from the point-in-time copy of the data image to the virtual snapshot storage device responsive to the data not existing in the virtual data image storage device.

2. The method of claim 1, further comprising:
generating data representing a mapping relationship between the virtual snapshot storage device and the virtual data image storage device for data not copied from the point-in-time copy of the data image.

3. The method of claim 1, wherein the data backup further comprises a further point-in-time copy of the data image, and wherein the method further comprises:
providing a further virtual snapshot storage device for storing data of the further point-in-time copy of the data image;
mapping the further virtual snapshot storage device to data of the virtual data image storage device;
determining whether data of the further point-in-time copy of the data image exists in the virtual data image storage device; and
copying data from the further point-in-time copy of the data image to the further virtual snapshot storage device responsive to the data of the further point-in-time copy of the data image not existing in the virtual data image storage device.

4. The method of claim 3, further comprising:
further mapping the further virtual snapshot storage device to data of the virtual snapshot storage device; and
determining whether data of the further point-in-time copy of the data image exists in the virtual snapshot storage device, wherein copying the data from the further point-in-time copy of the data image to the further virtual snapshot storage device is only undertaken responsive to the data of the further point-in-time copy of the data image not existing in the virtual snapshot storage device.

5. The method of claim 4, further comprising:
generating data representing a mapping relationship between the further virtual snapshot storage device and the virtual snapshot storage device and the virtual data image storage device for data not copied from the further point-in-time copy of the data image.

6. The method of claim 1, wherein the data backup has been created using a FlashCopy function, and wherein the data image is a Source image and the point-in-time copy of the data image is a Target image.

7. The method of claim 1, wherein the virtual data image storage device and the virtual snapshot storage device are provided in the same data storage device.

8. The method of claim 1, wherein the data backup is provided on computer readable medium or a network-accessible data repository.

9. A computer program product for recovering a data backup comprising a data image and a point-in-time copy of the data image, wherein the computer program product comprises a computer-readable storage medium having computer-readable program stored therein, the computer-readable program, when executed on a computing device, causes the computing device to:
provide a virtual data storage device for storing a copy of the data image;
copy the data image to the virtual data image storage device;
provide a virtual snapshot storage device for storing data of the point-in-time copy of the data image;
map the virtual snapshot storage device to data of the virtual data image storage device;
determine whether data of the point-in-time copy of the data image exists in the virtual data image storage device; and
copy data from the point-in-time copy of the data image to the virtual snapshot storage device responsive to the data not existing in the virtual data image storage device.

10. A computer system adapted to recover a data backup comprising a data image and a point-in-time copy of the data image, the system comprising:
a processor:
a memory coupled to the processor, wherein the memory comprises instructions which, when executed by the processor, cause the processor to:
provide a virtual data image storage device for storing a copy of the data image;
copy the data image to the virtual data image storage device;
provide a virtual snapshot storage device for storing data of the point-in-time copy of the data image,
map the virtual snapshot storage device to data of the virtual data image storage device;
determine whether data of the point-in-time copy of the data image exists in the virtual data image storage device; and
copy data from the point-in-time copy of the data image to the virtual snapshot storage device responsive to the data not existing in the virtual data image storage device.

11. The computer system of claim 10, wherein the instructions further cause the processor to:
generate data representing a mapping relationship between the virtual snapshot storage device and the virtual data image storage device for data not copied from the point-in-time copy of the data image.

12. The computer system of claim 10, wherein the data backup further comprises a further point-in-time copy of the data image, and wherein the instructions further cause the processor to:
provide a further virtual snapshot storage device for storing data of the further point-in-time copy of the data image;
map the further virtual snapshot storage device to data of the virtual data image storage device;
determine whether data of the further point-in-time copy of the data image exists in the virtual data image storage device; and
copy data from the further point-in-time copy of the data image to the further virtual snapshot storage device responsive to the data of the further point-in-time copy of the data image not existing in the virtual data image storage device.

13. The computer system of claim 12, wherein the instructions further cause the processor to:
further map the further virtual snapshot storage device to data of the virtual snapshot storage device; and
determine whether data of the further point-in-time copy of the data image exists in the virtual snapshot storage device, wherein copying the data from the further point-in-time copy of the data image to the further virtual snapshot storage device is only undertaken responsive to the data of the further point-in-time copy of the data image not existing in the virtual snapshot storage device.

14. The computer system of claim 13, wherein the instructions further cause the processor to:
generate data representing a mapping relationship between the further virtual snapshot storage device and the virtual snapshot storage device and the virtual data image storage device for data not copied from the further point-in-time copy of the data image.

15. The computer system of claim 10, wherein the data backup has been created using a FlashCopy function, and wherein the data image is a Source image and the point-in-time copy of the data image is a Target image.

16. The computer program product of claim 9, wherein the computer-readable program further cause the computing device to:
generate data representing a mapping relationship between the virtual snapshot storage device and the virtual data image storage device for data not copied from the point-in-time copy of the data image.

17. The computer program product of claim 9, wherein the data backup further comprises a further point-in-time copy of the data image, and wherein the computer-readable program further causes the computing device to:
provide a further virtual snapshot storage device for storing data of the further point-in-time copy of the data image;
map the further virtual snapshot storage device to data of the virtual data image storage device;
determine whether data of the further point-in-time copy of the data age exists in the virtual data image storage device; and
copy data from the further point-in-time copy of the data image to the further virtual snapshot storage device responsive to the data of the further point-in-time copy of the data image not existing in the virtual data image storage device.

18. The computer program product of claim 17, wherein the computer-readable program further cause the computing device to:
further map the further virtual snapshot storage device to data of the virtual snapshot storage device; and
determine whether data of the further point-in-time copy of the data image exists in the virtual snapshot storage device, wherein copying the data from the further point-in-time copy of the data image to the further virtual snapshot storage device is only undertaken responsive to the data of the further point-in-time copy of the data image not existing in the virtual snapshot storage device.

19. The computer program product of claim 18, wherein the computer-readable program further cause the computing device to:
generate data representing a mapping relationship between the further virtual snapshot storage device and the virtual snapshot storage device and the virtual data image storage device for data not copied from the further point-in-time copy of the data image.

20. The computer program product of claim 9, wherein the data backup has been created using a FlashCopy function, and wherein the data image is a Source image and the point-in-time copy of the data image is a Target image.
